(19) United States
(12) Patent Application Publication
(10) Pub. No.: US 2026/0016574 A1
(43) Pub. Date: Jan. 15, 2026

(54) OPA-BASED OPTICAL SCANNER SYSTEM USING METALENS

(71) Applicant: GIST(Gwangju Institute of Science and Technology), Gwangju (KR)

(72) Inventors: Nan Ei YU, Gwangju (KR); Rebeda Roy TALEM, Gwangju (KR); Sunder Meetei TOIJAM, Gwangju (KR)

(73) Assignee: GIST(Gwangju Institute of Science and Technology), Gwangju (KR)

(21) Appl. No.: 19/256,666

(22) Filed: Jul. 1, 2025

(30) Foreign Application Priority Data
Jul. 1, 2024 (KR) 10-2024-0086467

(51) Int. Cl. G01S 7/481; G02B 1/00

(52) U.S. Cl. CPC G01S 7/4817; G01S 7/4814; G02B 1/002

(57) ABSTRACT

The present disclosure relates to an OPA-based optical scanner system using a metalens, which includes an optical phased array antenna configured to modulate a phase of light input from a light source unit and output the light, and an optical unit installed on a path of light output from the optical phased array antenna and configured to focus or diffuse light output from the optical phased array antenna using a metalens.

### CROSS REFERENCE TO RELATED APPLICATION

The present application claims priority to Korean Patent Application No. 10-2024-0086467, filed Jul. 1, 2024, the entire contents of which are incorporated herein for all purposes by this reference.

### BACKGROUND

### Technical Field

The present disclosure relates to an OPA-based optical scanner system using a metalens, and more particularly, to an optical scanner system that focuses or diffuses light output from an optical phased array antenna using a metalens.

### Description of the Related Art

A LIDAR sensor for autonomous vehicles obtains 3D space information by measuring the time that an incident pulse laser takes to return after reflecting from an object. A LiDAR is, in a broad sense, classified into a “flash type” and a “scanning type” in accordance with the type of laser emission. The flash type is a method of simultaneously emitting laser beams to a wide area, in which a light receiving element is a 2D-array type such that a receiver can also recognize an image returning after reflecting. On the other hand, a scanning LiDAR performs point mapping if a 3D space by vertically and horizontally rotating a laser beam. Accordingly, it has a lower laser light source output and a simple light reception structure of the receiver in comparison to the flash type. An existing scanning LiDAR has a field of view of 360° by mechanical motor rotation.

However, in a basic mechanical LiDAR, the motor for rotation is heavy and a significant amount of power is consumed, so the mechanical LiDAR cannot be applied to unmanned aerial vehicles with limited power and weight requirements and the mechanical rotation speed does not meet the rotation speed required for autonomous vehicles to operate on highways.

An optical phased array antenna can distribute an incident laser to each antenna element through multiple directional couplers and can achieve desired propagation directions of output lasers by modulating the phase of the distributed lasers. In the case of a LiDAR with an optical phased array antenna in the related art, collimating lenses and expanding lenses are used to focus and diffuse the light emitted from the optical phased array antenna. However, such collimating lenses and expanding lenses have a relatively large volume, which makes it difficult to miniaturize a scanning system.

### PRIOR ART DOCUMENT

### Patent Document

(Patent Document 1) Registration No. 10-1924890: Optical Phased Array Antenna and LiDAR Having The Same

### SUMMARY

The present disclosure has been made in an effort to solve the problems described above and an objective of the present disclosure is to provide an OPA-based optical scanner system using a metalens that can focus or diffuse the light emitted from an optical phased array antenna using a metalens, instead of collimating lenses and expanding lenses that are widely used.

In order to achieve the objectives of the present disclosure, an OPA-based optical scanner system using a metalens according to the present disclosure includes: an optical phased array antenna configured to modulate a phase of light input from a light source unit and output the light, and an optical unit installed on a path of light output from the optical phased array antenna and configured to focus or diffuse light output from the optical phased array antenna using a metalens.

The optical unit may include: a first metalens installed on a path of light output from the optical phased array antenna and configured to focus the light; and a second metalens installed on a path of light emitted from the first metalens and configured to diffuse the light.

The first metalens may include: a first main substrate installed on a path of light output from the optical phased array antenna and transmitting the light; and multiple first meta-atoms formed on an exit surface of the first main substrate, through which light incident from the optical phased array antenna is emitted, to focus light passing through the first main substrate.

The first meta-atoms may protrude from a surface of the first main substrate and may be spaced apart from each other.

The first meta-atoms may be formed to have a circular cross-section with a predetermined radius.

The second metalens may include: a second main substrate disposed on a path of light emitted from the first metalens, through which the light passes; and multiple second and third meta-atoms respectively formed on an incident surface of the second main substrate to which light emitted from the first metalens is incident, and an exit surface of the second main substrate from which the light is emitted, in order to diffuse light passing through the second main substrate.

The second meta-atoms may protrude with respect to the incident surface of the second main substrate and may be spaced apart from each other.

The second meta-atoms may be formed to have a circular cross-section with a predetermined radius.

The third meta-atoms may protrude with respect to the exit surface of the second main substrate and may be spaced apart from each other.

The third meta-atoms may be formed to have a circular cross-section with a predetermined radius.

The OPA-based optical scanner system using the metalens according to the present disclosure has the advantages that it can achieve miniaturization by reducing the size of the system because the light emitted from the optical phased array antenna is focused and diffused by metalens, it is easy to manufacture through semiconductor processes, allows for mass production for commercialization, and improve system efficiency by enabling precise control of light focusing and diffusion.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a conceptual diagram of an OPA-based optical scanner using a metalens according to the present disclosure;

FIG. 2 is a diagram of a first metalens of the OPA-based optical scanner system using a metalens of FIG. 1;

FIG. 3 and FIG. 4 are simulation results of the metalens of the OPA-based optical scanner system using a metalens of the present disclosure;

FIG. 5 is a graph of FDTD (Finite Difference Time Domain) simulation results for the structure of the metalens;

FIG. 6 is a conceptual diagram of the first metalens;

FIG. 7 and FIG. 8 show phase masks for the x-axis and y-axis of the first metalens, and light paths;

FIG. 9 is a graph comparing the spot size of the light output from an optical phased array antenna depending on the presence or absence of the first metalens;

FIG. 10 is a conceptual diagram of a second metalens of the OPA-based optical scanner system using a metalens of the present disclosure; and

FIG. 11 and FIG. 12 are phase masks of metasurfaces 1 and 2 of the second metalens.

### DETAILED DESCRIPTION

Hereafter, an OPA-based optical scanner system using a metalens according to an embodiment of the present disclosure is described in detail with reference to the accompanying drawings. The present disclosure may be modified in various ways and implemented by various exemplary embodiments, so specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings. In the accompanying drawings, the dimensions of structures were exaggerated larger than the actual dimensions to make the present disclosure clear.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure.

The terms used herein are used only for the purpose of describing particular embodiments and are not intended to limit the present disclosure. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms have the same meanings as those that are generally understood by those who skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

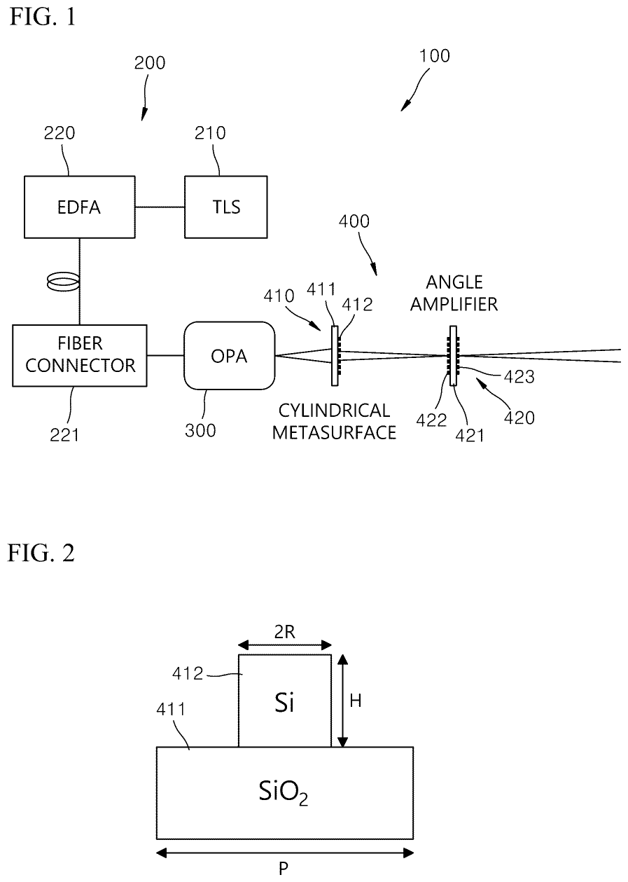

FIG. 1 and FIG. 2 show an OPA-based optical scanner system 100 using a metalens according to the present disclosure.

Referring to the drawings, the OPA-based optical scanner system 100 using a metalens includes an optical phased array antenna 300 that modulates the phase of light input from a light source unit 200 and outputs it, and an optical unit 400 that is installed on a path of the light output from the optical phased array antenna 300 and focuses or diffuses the light output from the optical phased array antenna 300 using a metalens.

The light source unit 200 includes a laser light source 210 that generates light, and an optical amplifier 220 that amplifies the light output from the laser light source 210 and outputs it to the optical phased array antenna 300.

As the laser light source 210, a laser generator (Tunable Laser Source (TLS)) that supplies a laser beam to the optical amplifier 220 is applied. As the optical amplifier 220, an amplification device (Erbium-Doped Fiber Amplifier (EDFA) for amplifying the laser beam input from the laser light source 210 is applied. Since a laser light source 210 and an optical amplifier 220 that are commonly used in LiDAR systems of the related art are applied as the laser light source 210 and the optical amplifier 220, and a detailed description is omitted. The optical amplifier 220 is connected to the optical phased array antenna 300 through an optical fiber and outputs amplified light to the optical phased array antenna 300. The optical phased array antenna 300 is connected to the optical fiber connected to the optical amplifier 220 through an optical fiber connector 221.

The optical phased array antenna 300, though not shown in the figures, includes a coupling part connected to the optical fiber connector 221 and receives the light output from the light source unit 200, a phase modulation module that modulates the phase of the light input from the coupling part, and an optical output part that outputs the modulated light from the phase modulation module and has an antenna element waveguide extended to a predetermined length to propagate the light. Meanwhile, an optical phased array antenna 300 commonly used in LiDAR systems of the related art is applied as the optical phased array antenna 300 described, and thus a detailed description is omitted.

The optical unit 400 includes a first metalens 410 that is installed on the path of the light output from the optical phased array antenna 300 and focuses the light, and a second metalens 420 that is installed on the path of the light emitted from the first metalens 410 and diffuses the light.

The first metalens 410 includes a first main substrate 411 that is installed on the path of the light output from the optical phased array antenna 300 and transmits the light, and multiple first meta-atoms 412 that is formed on the exit surface of the first main substrate, through which the light incident from the optical phased array antenna 300 is emitted, to focus the light passing through the first main substrate 411.

The first main substrate 411 is formed in a disc shape with a predetermined thickness. In this configuration, referring to FIG. 2, the first main substrate 411 is made of silicon dioxide (SiO₂) so that the light output from the optical phased array antenna 300 can pass through.

The first meta-atoms 412 are formed to protrude on the surface of the first main substrate 411, and are formed on the exit surface of the first main substrate 411 that is the opposite side of the incident surface where light is incident. The first meta-atoms 412 protrude to a predetermined height with respect to the exit surface of the first main substrate 411. In this configuration, the propagation direction of light refers to the propagation direction of light passing through the first main substrate 411. The first meta-atoms 412 are spaced apart from each other, and it is preferable that they are formed in the shape of a circular disc having a predetermined radius. The first meta-atoms 412 are made of silicon (Si).

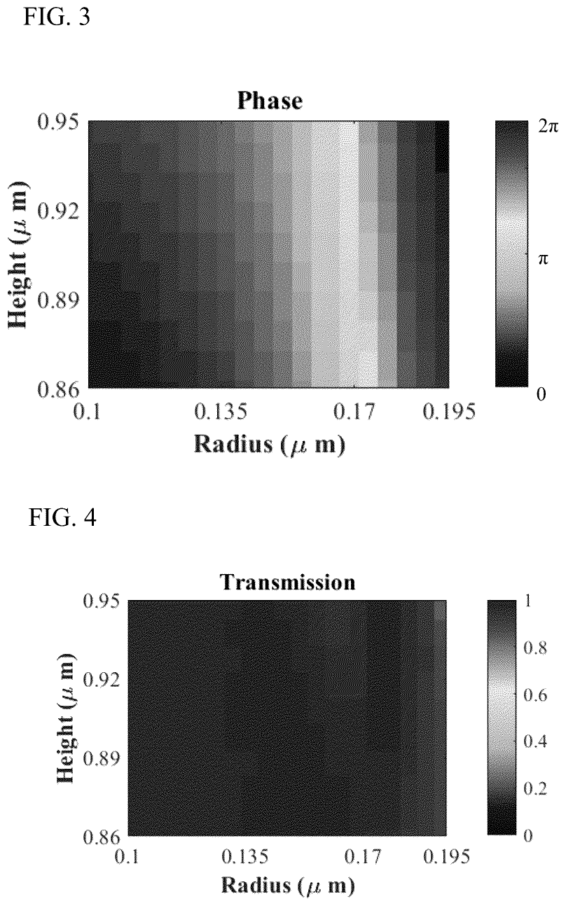

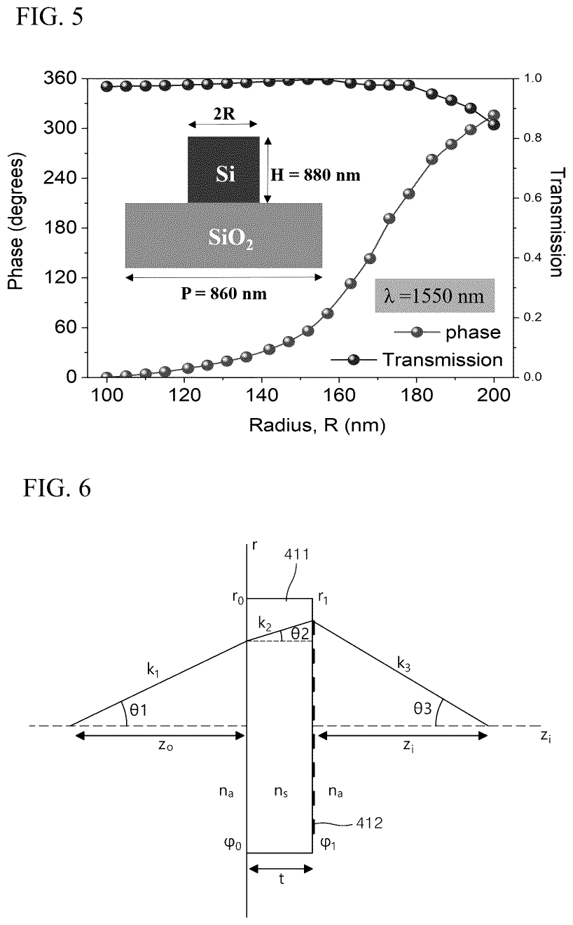

Meanwhile, in FIG. 3 and FIG. 4, simulation results for the metalens configured with the first main substrate 411 and first meta-atom 412 described above are shown. FIG. 3 shows the phase change of light passing through the metalens according to the protrusion height H of the meta-atoms and the radius R of the meta-atoms relative to the main substrate, while FIG. 4 shows the transmission change of light passing through the metalens according to the protrusion height H of the meta-atoms and the radius R of the meta-atoms relative to the main substrate. Further, a graph of FDTD (Finite Difference Time Domain) simulation results for the structure of the metalens is shown in FIG. 5. In this configuration, the protrusion height H of the meta-atoms relative to the main substrate is 880 nm, the period P of the meta-atoms is 860 nm, and the wavelength λ of light is 1550 nm. Meanwhile, the following Table 1 shows the result values of the phase change of light according to the change in the diameter of the meta-atoms.

TABLE 1

| Diameter of meta-atom, 2R | Phase |
|---|---|
| (nm) | (degree) |
| 200 | 0 |
| 267 | 22 |
| 296 | 45 |
| 310 | 67 |
| 318 | 90 |
| 326 | 112 |
| 334 | 135 |
| 339 | 157 |
| 343 | 180 |
| 350 | 202 |
| 357 | 225 |
| 362 | 247 |
| 372 | 270 |
| 384 | 292 |
| 399 | 315 |
| 423 | 337 |

Referring to the figures and Table 1, it can be seen that the light phase and light transmission of the metalens change as a function of the radius and protrusion height of the meta-atoms. In particular, meta-atoms with a diameter ranging from 200 to 423 nm can provide relatively complete phase control. Therefore, by changing the shape and arrangement of the meta-atoms, it is possible to manufacture metalenses that provide functions similar to various types of lenses (such as convex lenses, concave lenses, and axicon lenses). Meanwhile, FIG. 6 is a conceptual diagram of the first metalens 410. In this case, the left surface r₀ of the first main substrate 411 is the incident surface to which light is incident, and the right surface r₁ of the first main substrate 411 is the exit surface from which light is emitted. Multiple meta-atoms 412 are formed on the exit surface of the first main substrate 411. Further, k₁, k₂, and k₃ represent the incident, transmitted, and refracted vectors of light, respectively. ^{ϕ}^{ₒ} ϕ₀ and ϕ₁ represent the phase distribution at the incident surface and the exit surface of the first main substrate 411.

As shown in the figures, the light emitted from the optical phased array antenna 300 enters the first metalens 410 along the path of k₁, is transmitted along the path of k₂, and is refracted along the path of k₃ at the exit surface of the first main substrate 411 on which the first meta-atoms 412 are provided. As described above, the first metalens 410 focuses light output from the optical phased array antenna 300.

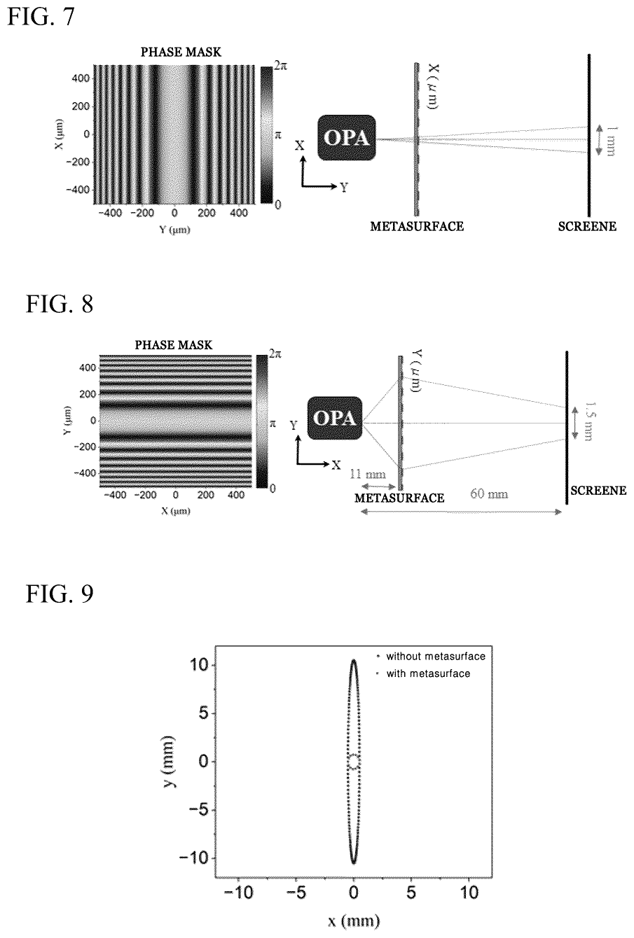

Meanwhile, FIG. 7 to FIG. 9 show the experimental results of the beam collimation characteristics of the optical phased array antenna 300 implemented with the first metalens 410. FIG. 7 and FIG. 8 show phase masks for the x-axis and y-axis of the first metalens 410, and light paths, and FIG. 9 is a graph comparing the spot size of light output from the optical phased array antenna 300 depending on the presence or absence of the first metalens 410. In these figures, the cyan region is the spot of light that has passed through the first metalens 410, and the blue region is the spot of light that has not passed through the first metalens 410. Referring to the figures, it can be seen that the light that has passed through the optical phased array antenna 300 is focused by the first metalens 410.

Meanwhile, the second metalens 420 includes a second main substrate 421 that is disposed on the path of the light emitted from the first metalens 410 and through which the light passes, and multiple second and third meta-atoms 422 and 423 respectively formed on the incident surface of the second main substrate 421 to which the light emitted from the first metalens 410 is incident, and the exit surface of the second main substrate from which the light is emitted, in order to diffuse the light passing through the second main substrate.

The second main substrate 421 is formed in a disc shape with a predetermined thickness. In this configuration, the second main substrate 421 is made of silicon dioxide (SiO₂), in the same manner as the first main substrate 411, so that the light that has passed through the first metalens 410 can pass through it.

The second meta-atoms 422 are formed to protrude on the surface of the second main substrate 421, and are formed on the incident surface of the second main substrate 421 to which light is incident. In this configuration, the second meta-atoms 422 protrude in the opposite direction to the propagation direction of light with respect to the incident surface of the second main substrate 421. The second meta-atoms 422 are spaced apart from each other, and it is preferable that they are formed in the shape of a circular disc having a predetermined radius. The second meta-atoms 422 are made of silicon (Si).

The third meta-atoms 423 are formed to protrude on the surface of the second main substrate 421, and are formed on the exit surface of the second main substrate 421 from which light is incident. In this configuration, the third meta-atoms 423 protrude in the propagation direction of light with respect to the exit surface of the second main substrate 421. The third meta-atoms 423 are spaced apart from each other, and it is preferable that they are formed in the shape of a circular disc having a predetermined radius. The third meta-atoms 423 are made of silicon (Si) to correspond to the second meta-atoms 422.

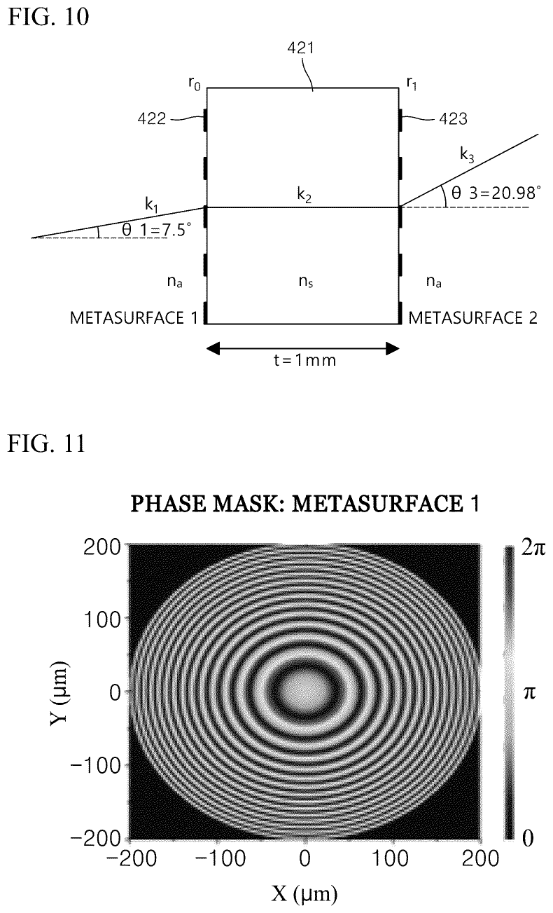

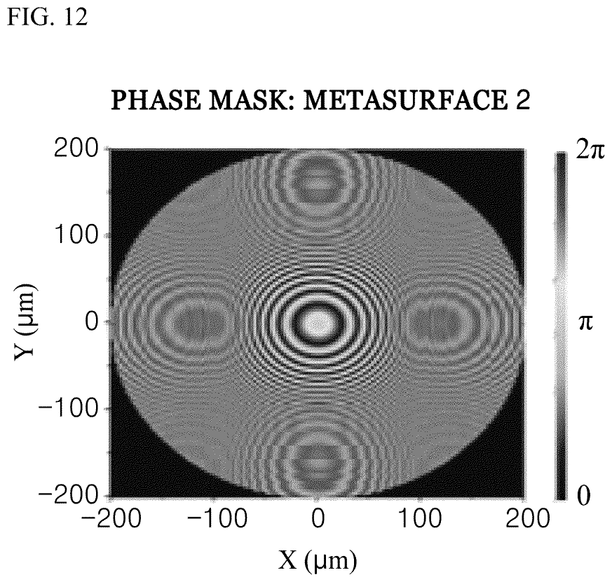

Meanwhile, FIG. 10 is a conceptual diagram of the second metalens 420. In this case, the left surface r₀ of the second main substrate 421 is the incident surface to which light is incident, and the right surface r₁ of the second main substrate 421 is the emission surface from which light is emitted. Multiple meta-atoms 422 and 423 are formed on the left surface and the right surface of the second main substrate 421, respectively. Further, k₁, k₂, and k₃ represent the incident, transmitted, and refracted vectors of light, respectively. In this state, an experiment was conducted on the expansion of the field of view of light output from the optical phased array antenna 300 using the second metalens 420. FIG. 11 and FIG. 12 show phase masks of the incident surface and exit surface of the second metalens 420, that is, the metasurfaces 1 and 2, in which the phase masks of the metasurfaces 1 and 2 have focal lengths of 900 μm and 300 μm, respectively, and a radius of 200 μm. The 64-channel optical phased array antenna 300 provides a field of view (FoV) of approximately 15 degrees, and the inclination of the light incident vector with respect to the second metalens 420 is given as 7.5 degrees. The optical path coordinates for the vectors k₁, k₂, and k₃ are as shown in the following Equation 1.

$${k}_{1} : {y}_{1} = - 0.13 {x}_{1} \qquad [ Equation 1 ]$$

$${k}_{2} : {y}_{2} = 0.0097 {x}_{2} - {r}_{0}$$

$${k}_{3} : {y}_{3} = - 0.3835 {x}_{3} - {r}_{1}$$

According to the experimental results, as shown in the figures, it can be seen that the light incident on the second metalens 420 at an angle of 7.5 degrees is emitted and output at approximately 20.98 degrees. That is, the field of view of light is amplified by approximately three times by the second metalens 420. Accordingly, the second metalens 420 can be effectively used to expand the field of view of incident light.

The OPA-based optical scanner system 100 using the metalens configured as described above in accordance with the present disclosure has advantages it the that can achieve miniaturization by reducing the size of the system because the light emitted from the optical phased array antenna 300 is focused and diffused by metalens, it is easy to manufacture through semiconductor processes, allows for mass production for commercialization, and improve system efficiency by enabling precise control of light focusing and diffusion.

The description of the proposed embodiments is provided to enable those skilled in the art to use or achieve the present disclosure. Various modifications of the embodiments would be apparent to those skilled in the art, and general principles defined herein may be applied to other embodiments without departing from the scope of the present disclosure. Therefore, the present disclosure is not limited to the embodiments proposed herein and should be construed in the widest range that is consistent with the principles proposed herein and new characteristics.

What is claimed is:

1. An OPA-based optical scanner system using a metalens, comprising:
an optical phased array antenna configured to modulate a phase of light input from a light source unit and output the light; and
an optical unit installed on a path of light output from the optical phased array antenna and configured to focus or diffuse light output from the optical phased array antenna using a metalens.

2. The OPA-based optical scanner system of claim 1, wherein the optical unit includes:
a first metalens installed on a path of light output from the optical phased array antenna and configured to focus the light; and
a second metalens installed on a path of light emitted from the first metalens and configured to diffuse the light.

3. The OPA-based optical scanner system of claim 2, wherein the first metalens includes:
a first main substrate installed on a path of light output from the optical phased array antenna and transmitting the light; and
multiple first meta-atoms formed on an exit surface of the first main substrate, through which light incident from the optical phased array antenna is emitted, to focus light passing through the first main substrate.

4. The OPA-based optical scanner system of claim 3, wherein the first meta-atoms protrude from a surface of the first main substrate and are spaced apart from each other.

5. The OPA-based optical scanner system of claim 3, wherein the first meta-atoms are formed to have a circular cross-section with a predetermined radius.

6. The OPA-based optical scanner system of claim 2, wherein the second metalens includes:
a second main substrate disposed on a path of light emitted from the first metalens, through which the light passes; and
multiple second and third meta-atoms respectively formed on an incident surface of the second main substrate to which light emitted from the first metalens is incident, and an exit surface of the second main substrate from which the light is emitted, in order to diffuse light passing through the second main substrate.

7. The OPA-based optical scanner system of claim 6, wherein the second meta-atoms protrude with respect to the incident surface of the second main substrate and are spaced apart from each other.

8. The OPA-based optical scanner system of claim 6, wherein the second meta-atoms are formed to have a circular cross-section with a predetermined radius.

9. The OPA-based optical scanner system of claim 6, wherein the third meta-atoms protrude with respect to the exit surface of the second main substrate and are spaced apart from each other.

10. The OPA-based optical scanner system of claim 6, wherein the third meta-atoms are formed to have a circular cross-section with a predetermined radius.
